(19) United States
(12) Patent Application Publication
(10) Pub. No.: US 2013/0282912 A1
(43) Pub. Date: Oct. 24, 2013

(54) CONNECTION ESTABLISHING METHOD BETWEEN TWO ELECTRONIC DEVICES AND SYSTEM APPLYING THE SAME

(71) Applicant: ASUSTEK COMPUTER INC, Taipei (TW)

(72) Inventors: Ting-Shuo YO, Taipei (TW); Chia-Hsin YANG, Taipei (TW); Yang-Po CHIU, Taipei (TW)

(73) Assignee: Asustek Computer Inc, Taipei (TW)

(21) Appl. No.: 13/863,008

(22) Filed: Apr. 15, 2013

Related U.S. Application Data
(60) Provisional application No. 61/637,476, filed on Apr. 24, 2012.

(30) Foreign Application Priority Data
Mar. 12, 2013 (TW) 102108702

(51) Int. Cl. H04L 29/08

(52) U.S. Cl. CPC H04L 67/14
USPC 709/228

(57) ABSTRACT

A connection establishing method between two electronic devices is disclosed, which includes following steps: activating a connection establishing program in a first electronic device; searching at least one specified electronic device; reading a storage unit, wherein the storage unit includes a database, and the database stores a plurality of corresponding connection modes between a plurality of second electronic devices and the first electronic device; pairing the searched specified electronic device with the database. If the second electronic devices include the specified electronic device, a connection between the specified electronic device and the first electronic device is established according to the corresponding connection mode. If the second electronic devices do not include the specified electronic device, a connection mode between the specified electronic device and the first electronic device is established and the database is updated.

### CROSS-REFERENCE TO RELATED APPLICATION

This application claims the priority benefit of provisional application Ser. No. 61/637,476, filed on Apr. 24, 2012, and Taiwan application serial No. 102108702, filed on Mar. 12, 2013. The entirety of the above-mentioned patent applications is hereby incorporated by reference herein and made a part of specification.

### BACKGROUND OF THE INVENTION

1. Field of the Invention

The invention relates to a connection establishing method between electronic devices and a system applying the same and, more particularly, to a connection establishing method and a connection establishing system using a single connection establishing interface.

2. Description of the Related Art

As electronic communication technology develops, electronic devices with a transferring function, such as a smart phone, a computer, a personal digital assistant (PDA) or a television (TV), are widely used. Users usually use the electronic device to share documents, transfer media messages and remote control with another device with the transferring function via mobile interne or wireless communication.

Internet connection protocols, such as worldwide interoperability for microwave access (WiMAX), Wi-Fi, 3 G or 4 G communication protocol for mobile devices, are developed for the electronic device to connect to a server or other devices. Different communication protocols and connection modes can help the user to connect the electronic device to different devices.

However, since the electronic device and its applicable communication protocol have various types and modes, it is complicated to set a connection and use it between devices. Since many users with limited relating acknowledge do not know how to set the network connection they cannot use a cross-device connection function after they buy an electronic device. Moreover, different types of the electronic devices use different connection methods according to the functions or device requirements. For example, when the electronic device shares documents or executes a video streaming function, it uses Wi-Fi, and when the electronic device is connected to a small device, such as an earphone, a microphone or a controller, it uses Bluetooth. Since the settings of various communication protocols are different and interfaces are independent, the user should know various technologies to use them.

### BRIEF SUMMARY OF THE INVENTION

A connection establishing method between electronic devices include following steps: activating a connection establishing program in a first electronic device; searching at least one specified electronic device; reading a storage unit, wherein the storage unit includes a database, and the database stores a plurality of corresponding connection modes between a plurality of second electronic devices and the first electronic device; and pairing the searched specified electronic device with the storage unit. If the second electronic devices include the specified elect device, a connection between the specified electronic device and the first electronic device is established according to the corresponding connection mode, and if the second electronic devices do not include the specified electronic device, a connection mode between the specified electronic device and the first electronic device is established and the database is updated.

A connection establishing system between electronic devices includes a first electronic device, a storage unit and a connection establishing device. The storage unit is connected to the first electronic device and includes a database. The database includes a plurality of corresponding connection modes between a plurality of second electronic devices and the first electronic device. The connection establishing device is disposed in the first electronic device. The connection establishing device includes a searching unit, a reading unit and a pairing unit. The searching unit searches at least one specified electronic device. The reading unit reads data in the database. The pairing unit pairs the searched specified electronic device with the database. If the second electronic devices of the database include the specified electronic device, a connection between the specified electronic device and the first electronic device is established according to the corresponding connection mode, and if the second electronic devices of the database do not include the specified electronic device, a connection mode between the specified electronic device and the first electronic device is established and the database is updated.

As stated above, the connection establishing method between electronic devices and the system applying the same use the connection establishing program, and thus a single operation interface can be used for setting the connection between the electronic devices with different communication protocols. The database corresponding to the connected electronic devices is established to form a social network between the electronic devices. Thus, the operable devices are filtered out for the user automatically by recognizing the identity (ID) of the devices in the next connection, and the connection mode adapted to the current operating devices is automatically selected, which can ease the burden of the user.

Furthermore, the user only needs to set once to finish the cross communication protocol connection in the single interface, which simplifies the connection steps and improves using convenience.

These and other features, aspects and advantages of the present invention will become better understood with regard to the following description, appended claims, and accompanying drawings.

### BRIEF DESCRIPTION OF THE DRAWINGS

FIG. 1A is a flow chart showing steps of a connection establishing method between an electronic devices in a first embodiment;

FIG. 1B is a block diagram showing a connection establishing system applying the connection establishing method in FIG. 1A;

FIG. 1C to FIG. 1H are schematic diagrams showing continuous operations of the connection establishing method in FIG. 1A;

FIG. 2A is a flow chart showing steps of a connection execution method between electronic devices in a second embodiment;

FIG. 2B and FIG. 2C are schematic diagrams showing continuous operations of the connection execution method in FIG. 2A; and

FIG. 2D and FIG. 2E are schematic diagrams showing continuous operations of the connection execution method in FIG. 2A in another embodiment.

### DETAILED DESCRIPTION OF THE EMBODIMENTS

A connection establishing method between electronic devices and a system applying the same are illustrated with relating figures, and the same symbols denote the same components.

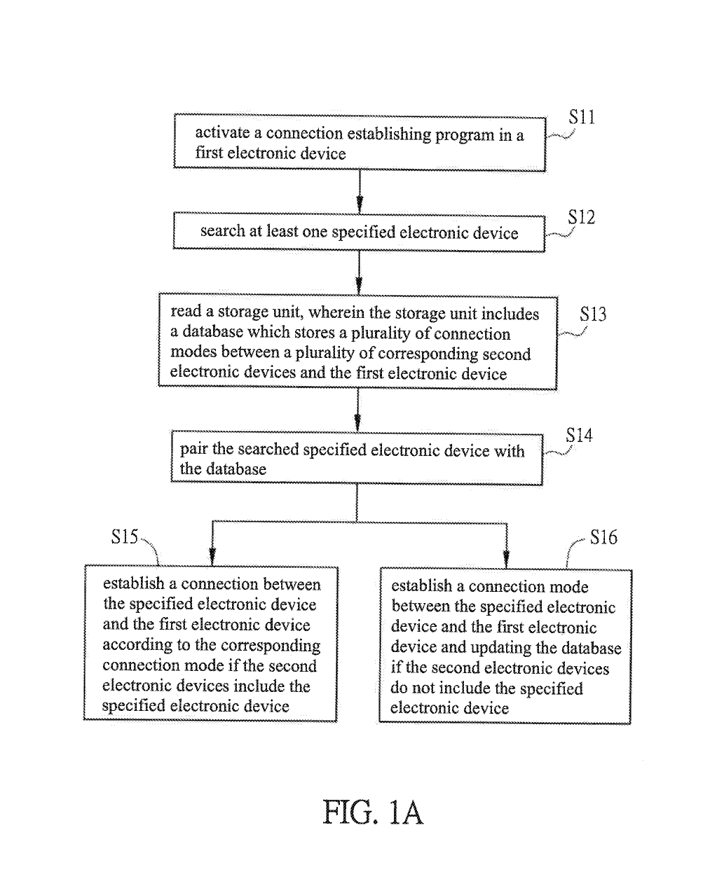

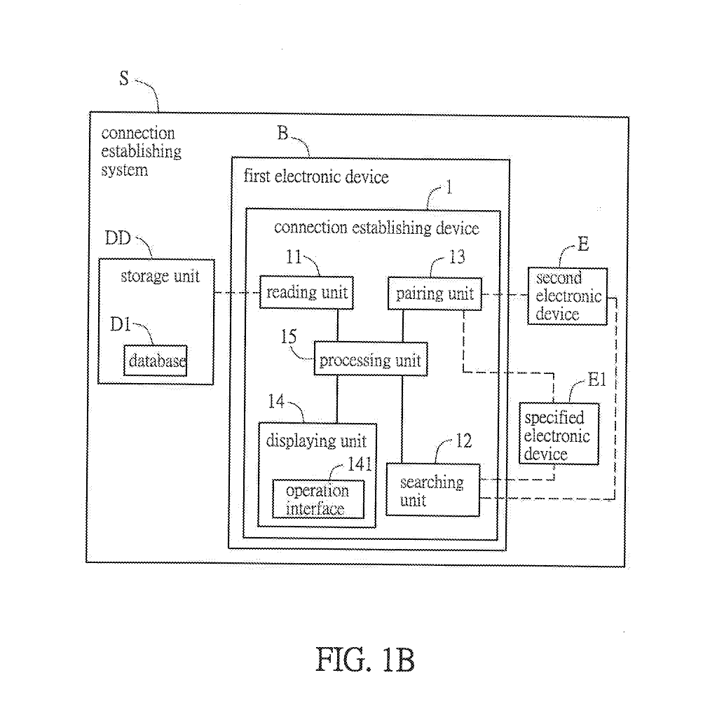

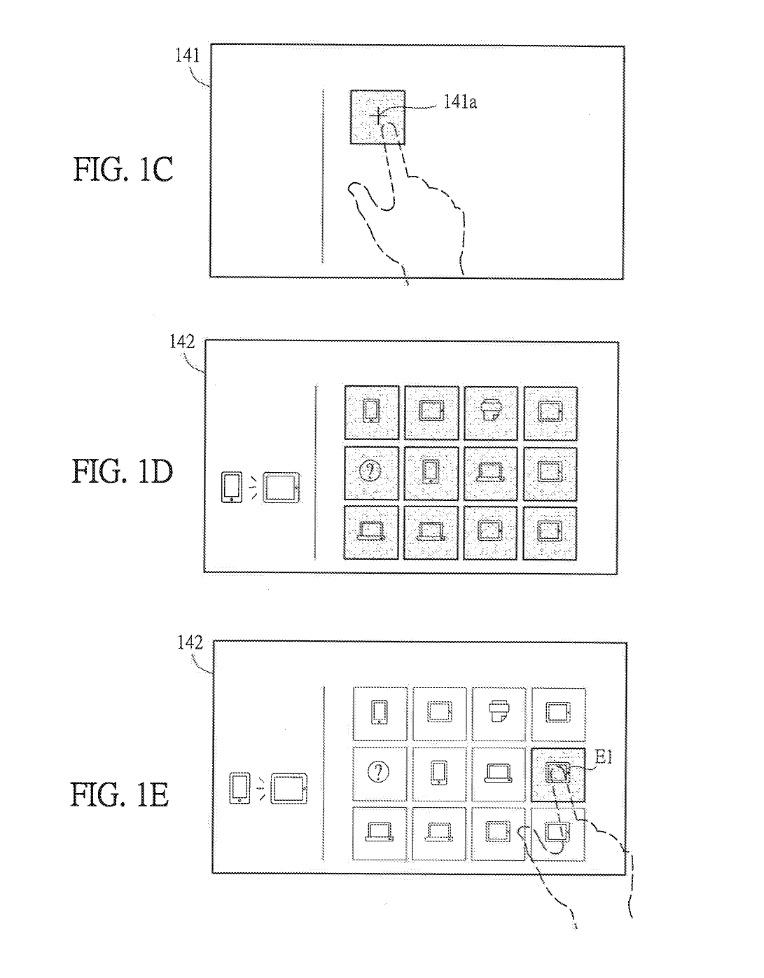

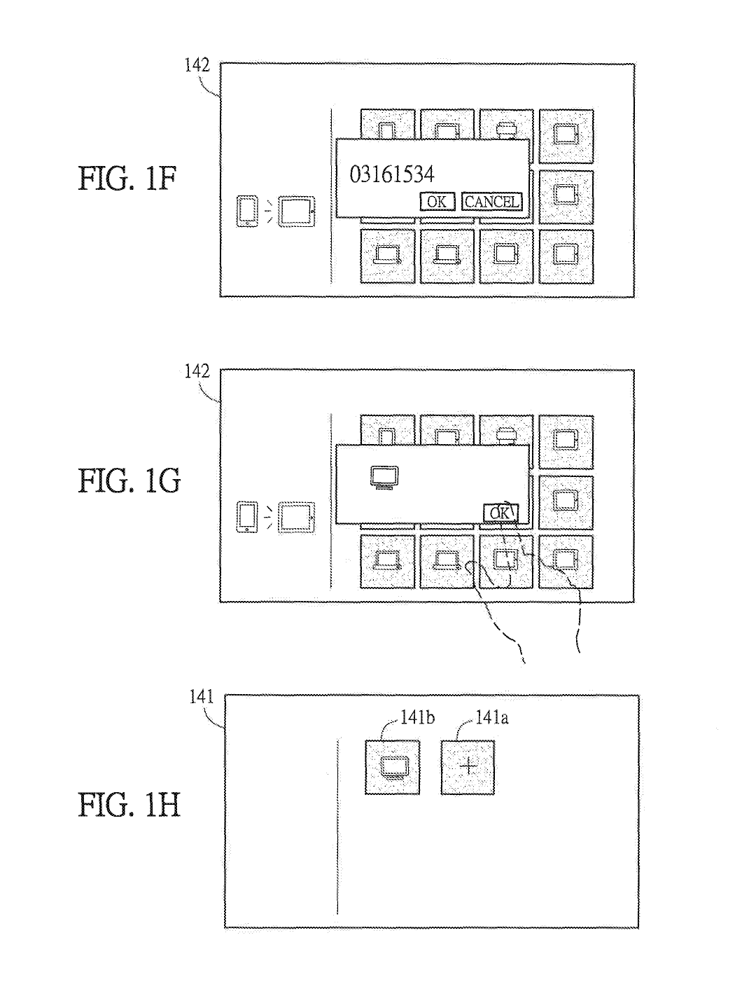

FIG. 1A is a flow chart showing steps of a connection establishing method between an electronic devices in a first embodiment. Please refer to FIG. 1A, in the embodiment, the connection establishing method between the electronic devices includes following steps: activating a connection establishing program in a first electronic device (S11); searching at least one specified electronic device (S12); reading a storage unit, wherein the storage unit includes a database, and the database stores a plurality of corresponding connection modes between a plurality of second electronic devices and the first electronic device (S13); pairing the searched specified electronic device with the storage unit (S14); building a connection between the specified electronic device and the first electronic device according to the corresponding connection mode if the second electronic devices include the specified electronic device (S15); establishing a connection mode between the specified electronic device and the first electronic device and updating the database if the second electronic devices do not include the specified electronic device (S16).

In order to illustrate the connection establishing method in the embodiment more clearly, a connection establishing system between the electronic devices (which is called “the connection establishing system” for short hereinafter) is taken as an example, and it connects a first electronic device with at least one peripheral specified electronic device E1, which is not limited herein.

FIG. 1B is a block diagram showing a connection establishing system applying the connection establishing method in FIG. 1A. Please refer to FIG. 1A and FIG. 1B, the connection establishing system S includes a first electronic device B, a second electronic device E and a storage unit DD. In the embodiment, the storage unit DD is separated from the first electronic device B and is connected to the first electronic device B in a wired way or a wireless way. The storage unit may also be established in the first electronic device, which is not limited herein.

The first electronic device B, the specified electronic device E1 and the second electronic device E are devices with a basic calculating function, such as a desktop computer, a notebook computer, a tablet computer, a smart phone or a smart television, which is not limited herein.

The first electronic device B includes a connection establishing device 1 and can be connected to the specified electronic device E1 via the connection establishing device 1. In the embodiment, the connection establishing device 1 includes a reading unit 11, a searching unit 12, a pairing unit 13, a displaying unit 14 and a processing unit 15 which are electrically connected to each other to transmit signals.

The specified electronic device E1 and the second electronic device E are pre-established a connection establishing program in the form of software or firmware. The user can connect different devices using one operating method via the software or the firmware. Even though the devices use different communication protocols, a cross communication protocol setting can be finished and a connection is established via the software or the firmware. Moreover, the second electronic device E is the electronic device which has been connected to the first electronic device B and the connection mode correspondingly is already established. The connection establishing system may include multiple second electronic devices E, and one second electronic device E is taken as an example in the embodiment, which is not limited herein.

FIG. 1C to FIG. 1H are schematic diagrams showing continuous operations of the connection establishing method in FIG. 1A. Please refer to FIG. 1A to FIG. 1H, in step S11, a connection establishing program of the first electronic device B is activated. “Activate” means starting the software or the firmware. When the software or the firmware is started, the reading unit 11 of the connection establishing device 1 is connected to the storage unit DD and reads data in the storage unit DD. In the embodiment, the first electronic device B establishes a connection with the specified electronic device E for the first time, and thus the storage unit DD does not include information relating to the specified electronic device E and the corresponding connection mode. When the first electronic device B finishes the connection establishing with the specified electronic device for the first time, the storage unit DD stores the relating information of the specified electronic device and the corresponding connection mode.

After the reading unit 11 reads the storage unit DD, the processing unit 15 controls the displaying unit 14 to display an operation interface 141. The operation interface 141 includes an adding option 141a, and the user can select the adding option 141a to execute an adding program (as shown in FIG. 1C).

Moreover, when the reading unit 11 reads the storage unit DD, the processing unit 15 controls the searching unit 12 to search the specified electronic device E1 in step S12. In the embodiment, the searching unit 12 searches the electronic device in a detection area via Bluetooth, and the searched electronic devices are displayed in the adding interface 142 (as shown in FIG. 1D). The searching unit 12 may also searches via near field communication (NFC), wireless fidelity (Wi-Fi), ZigBee or Z-wave, which is not limited herein.

The adding interface 142 is a sub interface of the operation interface 141. The connection between the first electronic device B and the specified electronic device E1 are set at one interface.

When the searching unit 12 finishes searching, the user selects a specified electronic device E1 to be connected in the adding interface 142 (as shown in FIG. 1E). After selection, the searched and selected specified electronic device E1 is paired with the storage unit DD via the pairing unit 13 in step S14. The two electronic devices are paired via a personal identification number (PIN) (as shown in FIG. 1F).

As stated above, after the pairing of the two electronic devices (the storage unite and the specified electronic device) is finished and confirmed (as shown in FIG. 1G), the connection mode between the specified electronic device E1 and the first electronic device B is established in step S15. When the two electronic devices (the first electronic device and the specified electronic device) are connected, the processing unit 15 accesses the information of the specified electronic device E1 and updates the database D1, so as to establish the connection mode corresponding to the specified electronic device E1 in the storage unit DD. “The information” of the specified electronic device E1 means the connectivity, the connection mode, the type and the relation with the first electronic device B. The relating information of the specified electronic device E1 is stored in the database D1, and the first electronic device reads the database D1 automatically according to the information in the next connection, so as to provide appropriate service or a corresponding connection mode rapidly.

In step S16, after the database D1 is updated, the operation interface 141 displays a first reading option 141b corresponding to the specified electronic device E1 near the adding option 141a (as shown in FIG. 1H), and thus the user can select it when the first electronic device B activates the connection establishing program next time. That is, the connection setting of various specified electronic devices E1 can be finished in one same operating way and a single interface via the connection establishing program, which simplifies the connection setting of different specific electronic devices E1.

If the second electronic device includes the specified electronic device, which, means the connection between the specified electronic device and the first electronic device has been established before, a connection between the specified electronic device and the first electronic device is established according to the corresponding connection mode, and the connection method is illustrated hereinafter.

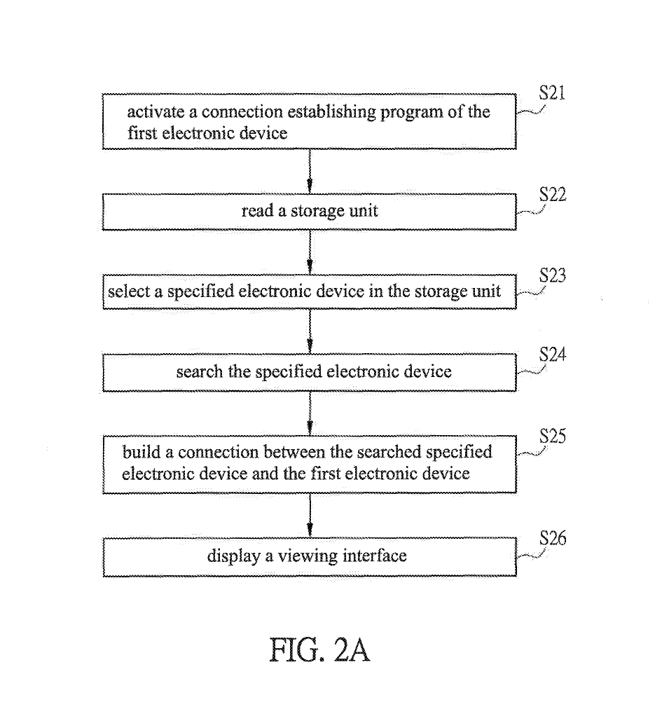

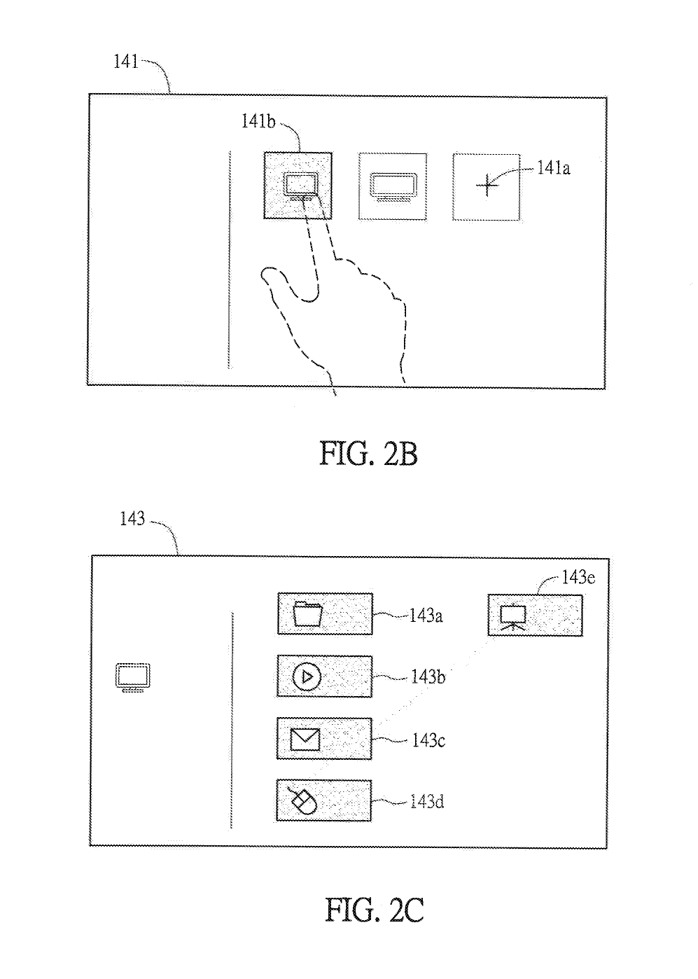

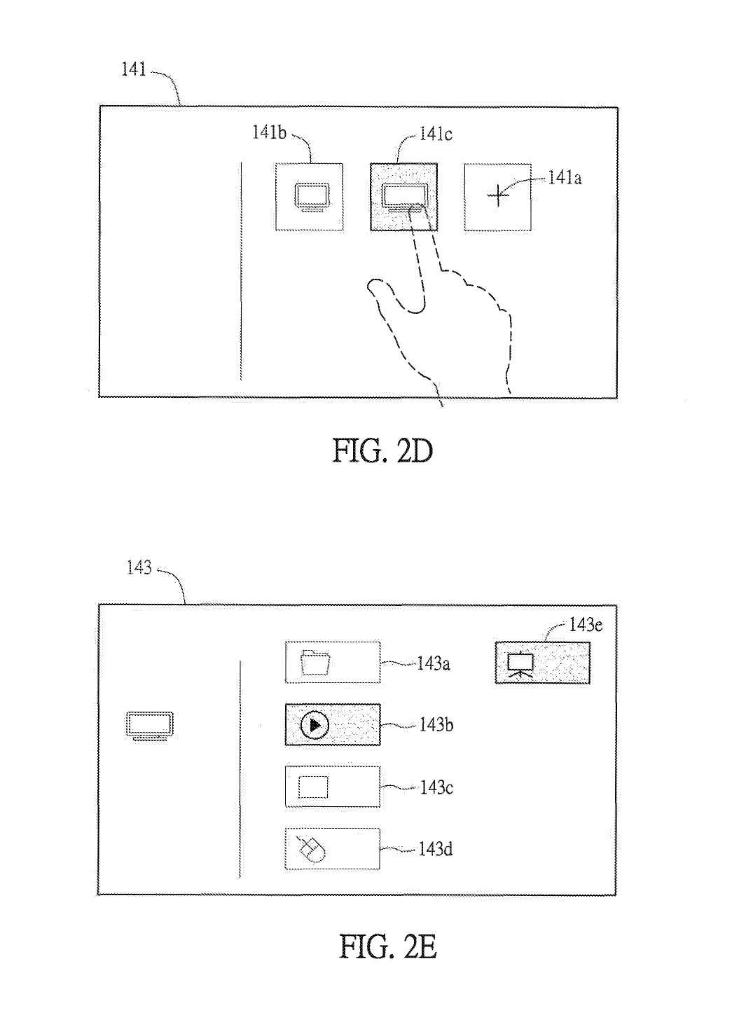

FIG. 2A is a flow chart showing steps of a connection execution method between electronic devices in a second embodiment. Please refer to FIG. 2A, the connection execution method includes following steps: activating a connection establishing program of the first electronic device (step S21); reading a storage unit (step S22); selecting a specified electronic device in the storage unit (step S23); searching the specified electronic device (step S24); building a connection between the searched specified electronic device and the first electronic device (step S25); displaying a viewing interface (step S26). The specified electronic device in the second embodiment means the second electronic device E. After the corresponding connection between the first electronic device B and the second electronic device E is established, the first electronic device B is connected to the second electronic device E for the second time in the embodiment.

FIG. 2B and FIG. 2C are schematic diagrams showing continuous operations of the connection execution method in FIG. 2A. Please refer to FIG. 1B, FIG. 2A, FIG. 2B and FIG. 2C, in the embodiment, the adding option 141a and the first reading option 141b displayed in the operation interface 141 are illustrated in the above embodiments, which is omitted herein. In step S21, the connection establishing program of the first electronic device B is activated. When the software or the firmware of the connection establishing program is started, the reading unit 11 of the connection establishing device 1 is connected to the storage unit DD and reads the data in the storage unit DD. In the second embodiment, this is not the first time the connection between the second electronic device E and the first electronic device B established, and the storage unit DD stores the database D1 corresponding to the second electronic device E. Thus, in step S23, the user can directly select the first reading option 141b corresponding to the second electronic device E at the operation interface 141 (as shown in FIG. 2B), and step S24 is executed to search the second electronic device E. The second electronic device E is searched via wireless connection, which is not limited herein.

Since the connection between the first electronic device B and the second electronic device E has been established already for the first time, the authenticating of the second electronic device E and the pairing of the two electronic devices are finished automatically, which does not need the user's operation. Moreover, the connection mode adapted to the current operating devices is automatically selected, which can ease the burden of the user.

After the two electronic devices (the first electronic device and the second electronic device) are connected, a viewing interface 143 is displayed in step S25 (as shown in FIG. 2C). The viewing interface 143 displays available services of the second electronic device E for the first electronic device to remote operate. In the embodiment, the available services of the second electronic device E include options such as document file selection 143a, music play 143b, mails 143c, mouse control 143d and video play 143e, and the options displayed at the viewing interface 143 are preset by the manufacturers, which is not limited herein.

The viewing interface 143 is a sub interface of the operation interface 141. The connections between the first electronic device B and the second electronic devices are also set in one single interface.

FIG. 2D and FIG. 2E are schematic diagrams showing continuous operations of the connection execution method in FIG. 2A in another embodiment. In the embodiment, the selected second electronic device in step S23 is a television (not shown), and the television has been connected to the first electronic device B before. Thus, the storage unit DD stores the database corresponding to the television, and a second reading option 141c corresponding to the television is displayed at the operation interface 141 (as shown in FIG. 2D). When the second reading option 141c is selected, the viewing interface 143 displays available services of the television, which include music play 143b and video play 143e, as shown in FIG. 2E. Other services cannot be provided by the television, and thus they are not optional.

As stated above, the first electronic device B filters out the operable devices for the user by reading the data of the storage unit DD and recognizing the identity (ID) of the devices, and the connection mode adapted to the current operating devices is automatically selected, which can ease the burden of the user.

A connection establishing system between electronic devices applying the method above is also provided. The structure, features and way of implementing of the connection establishing system are similar to those of the connection establishing system S stated in the above embodiments, which is omitted herein.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed:

1. A connection establishing method between electronic devices comprising following steps:
activating a connection establishing program in a first electronic device;
searching at least one specified electronic device;
reading a storage unit, wherein the storage unit includes a database, and the database stores a plurality of corresponding connection modes between a plurality of second electronic devices and the first electronic device; and
pairing the searched specified electronic device with the database,
wherein if the specified electronic device is included by the second electronic devices in the database, a connection between the specified electronic device and the first electronic device is established according to the corresponding connection mode, and if the specified electronic device is not included by the second electronic devices in the database, a connection mode between the specified electronic device and the first electronic device is established and the database is updated.

2. The connection establishing method according to claim 1, wherein the connection establishing program is software or firmware established in the first electronic device and the specified electronic device.

3. The connection establishing method according to claim 1, wherein the connection establishing method further includes:
displaying an operation interface and selecting an adding option at the operation interface after the connection establishing program is activated.

4. The connection establishing method according to claim 3, wherein the connection establishing method further includes:
adding the specified electronic device to an adding interface if the specified electronic device is not included by the second electronic devices in the database after the specified electronic device is paired with the database.

5. The connection establishing method according to claim 1, wherein the connection establishing method further includes:
mutually authenticating the specified electronic device and the first electronic device after the connection between the searched specified electronic device and the first electronic device is established.

6. The connection establishing method according to claim 5, wherein methods of authenticating include pairing buttons, a personal identification number (PIN), a radio frequency identification (RFID) or a quick response code (QR Code).

7. The connection establishing method according to claim 1, wherein the connection mode includes one or a combination of near field communication (NFC), Bluetooth, wireless fidelity (Wi-Fi), ZigBee or Z-wave.

8. A connection establishing system between electronic devices, comprising:
a first electronic device;
a storage unit connected to the first electronic device and including a database, wherein the database includes a plurality of corresponding connection modes between a plurality of second electronic devices and the first electronic device; and
a connection establishing device disposed in the first electronic device, wherein the connection establishing device includes:
a searching unit searching at least one specified electronic device;
a reading unit reading data in the database; and
a pairing unit paring the searched specified electronic device with the database, wherein if the second electronic devices of the database include the specified electronic device, a connection between the specified electronic device and the first electronic device is established according to the corresponding connection mode, and if the second electronic devices of the database do not include the specified electronic device, a connection mode between the specified electronic device and the first electronic device is established and the database is updated.

9. The connection establishing system according to claim 8, wherein the connection establishing system further includes:
a displaying unit displaying an operation interface which includes an adding option.
